(19) United States
(12) Patent Application Publication
(10) Pub. No.: US 2021/0331445 A1
(43) Pub. Date: Oct. 28, 2021

(54) Adhesive Structure and Adhesive Method for Adhering Panel to System Frame

(71) Applicant: Wuhan China Star Optoelectronics Semiconductor Display Technology Co., LTD., Wuhan, Hubei (CN)

(72) Inventor: Chihshun TANG, Wuhan, Hubei (CN)

(73) Assignee: Wuhan China Star Optoelectronics Semiconductor Display Technology Co., Ltd., Wuhan, Hubei (CN)

(21) Appl. No.: 16/485,440

(22) PCT Filed: Apr. 25, 2019
(86) PCT No.: PCT/CN2019/084169

§ 371 Date: Aug. 12, 2019

(30) Foreign Application Priority Data
Jan. 31, 2019 (CN) 201910100451.5

(51) Int. Cl. B32B 7/12; B32B 3/06; B32B 37/12; B32B 38/00; B32B 17/00; B32B 37/26

(52) U.S. Cl. CPC B32B 7/12; B32B 3/06; B32B 37/12; B32B 38/0004; B32B 2307/412; B32B 37/26; B32B 2037/268; B32B 2457/20; B32B 17/00

(57) ABSTRACT

An adhesive structure for adhering a panel to a system frame includes the system frame and the panel. The panel includes a glass cover, a display layer, and an optically clear adhesive (OCA). The display layer is configured to display images. The OCA is configured to adhere the glass cover and the display layer. There are partly OCAs disposed at two ends of the OCA. The partly OCAs are part exceed a width of the display layer. The partly OCAs are disposed between the display layer and system frame for adhering the display layer and system frame. By utilizing The adhesive structure for adhering the panel to the system frame, manufacturing processes of panels can be simplified. Light leaking when watching the panel at a wider viewing angle is improved.

### FIELD OF INVENTION

The present disclosure relates to a field of display panel, particularly to a field to an adhesive structure of display panel by utilizing optically clear adhesive.

### FIELD OF INVENTION

In present smart terminals, phones having glass covers with static curvatures utilize cutting frame adhesive (such as double-sided adhesive or foam glue), dispensing adhesive, adhesive tape, and other sticking method to adhere display panel modules and system frames. Nowadays, optically clear adhesive (OCA) is most widely used on adhering display panel module and system frame in touch display panel. OCA is suitable for adhering structures with portions of bends. The adhering capability between the display panel module and the system frame depends on material, thickness, length, and adhesion of the OCA. However, display areas on display panels become lager and the edge of frames become narrower. Therefore, spaces for adhering display panel modules and system frame are limited, especially for phones having glass covers with static curvatures. Therefore, the assembling reliabilities of the display panel modules and system frames are affected.

### Technical Problems

Please refer to FIG. 1 which illustrates a present adhesive structure for adhering display panels and system frames applied on phones having glass covers with static curvatures. As shown in FIG. 1, display panel 10 includes a glass cover 11, an OCA 12, a display layer 13, a foam adhesive 14, a frame adhesive 15, ink 16, and a system frame 17. A side line L1 is a border of active area (display area). A side line L2 is a border of view area. The side line 12 is also a border of the ink 16. A side line L3 is a border of display layer 13. A side line L4 and a side line L5 are two borders of the frame adhesive 15. In the panel 10, OCA 12 is utilized to adhere glass cover 11 and display layer 13 in the present phones having glass covers with static curvatures. If a distance between the border of active area (i.e. side line L1) and the border of view area (i.e. side line L2) is too closed, the ink 16 on the glass cover 11 may cover the view area so that displaying quality may be affected. If a distance between the view area and the border of display layer 13 (i.e. side line L3) is too closed, light leaking may happen while watching at wider viewing angles.

In addition, the present foam adhesive 14 is double-sided adhesive tape for adhere the display layer 13 and the system frame 17. Double-sided adhesive tape not only requires extra adhering components in the present adhesive structure for adhering panels to system frames, but also enlarges a distance between the display layer 13 and the system frame. As a result, a gap between the display panel module and the system frame is enlarged.

Hence, an adhesive structure for adhering a display panel to a system frame is required to solve problems of light leaking in wide viewing angles resulted from the gap between the display panel module and the system frame.

### SUMMARY OF INVENTION

The present disclosure provides An adhesive structure for adhering a panel to a system frame including the system frame, the panel, a frame adhesive, and a foam glue. The panel includes a glass cover, a display layer, and an optically clear adhesive (OCA). The display layer configured to display images. The OCA configured to adhere the glass cover and the display layer. The frame adhesive disposed between the glass cover and the system frame for adhering the glass cover and the system frame. The foam glue disposed between the display layer and the system frame for being a buffer between the display layer and the system frame. The OCA comprises partly OCA dispose at edge of the OCA; the partly OCA is a part of OCA which wider than the display layer; the partly OCA is disposed between the display layer and the system frame for adhering the display layer and the system frame.

The present disclosure further provides An adhesive structure for adhering a panel to a system frame including the system frame and the panel. The panel includes a glass cover, a display layer, and an OCA. The display layer configured to display images. The OCA configured to adhere the glass cover and the display layer. The OCA comprises partly OCA dispose at edge of the OCA. The partly OCA is a part of OCA which wider than the display layer; the partly OCA is disposed between the display layer and the system frame for adhering the display layer and the system frame.

Preferably, The adhesive structure for adhering the panel to the system frame further includes a frame adhesive disposed between the glass cover and the system frame for adhering the glass cover and the system frame.

Preferably, The adhesive structure for adhering the panel to the system frame further includes a foam glue disposed between the display layer and the system frame for being a buffer between the display layer and the system frame.

The present disclosure further provides An adhesive method for adhering the panel and to system frame includes step one: cutting a light release film into a first light release film and a second light release film, wherein the light release film is on a first side of an optically clear adhesive OCA; a width of the first light release film and a width of a display layer is equal; the second light release film is laterally disposed beside the first light release film; step two: removing the first light release film and sticking the OCA on the display layer, wherein a width of the OCA is wider than the width of the display layer; step three: bending the second light release film and parts of OCA being wider than the display layer down to the display layer; step four: removing the second light release film and adhering the display layer on the system frame through the parts of OCA being bent down to the display layer.

Preferably, the step one includes cutting a heavy release film into a first heavy release film and a second heavy release film, wherein the heavy release film is on a second side of the OCA. A width of the first heavy release film and a width of the display layer is equal. The second heavy release film is laterally disposed beside the first heavy release film.

Preferably, the step two includes removing the first heavy release film and adhering a glass cover on the OCA.

Preferably, the step two comprises removing the second heavy release film after adhering the glass cover on the OCA.

Preferably, a width of the film and a width of the heavy release film are wider than the display layer; the width of the film is wider than the width of the heavy release film.

Preferably, The adhesive method for adhering the panel to the system frame further includes a frame adhesive disposed between the glass cover and the system frame for adhering the glass cover and the system frame

Preferably, The adhesive method for adhering the panel to the system frame further includes a foam glue disposed between the display layer and the system frame for being a buffer between the display layer and the system frame.

### Beneficial Effect

The advantages of the present disclosure is adhering the glass cover, the display layer, and the system frame by utilizing one layer of the OCA. Hence, steps of assembling the glass cover, the display layer, and the system frame can be simplified. Also manufacturing processes of panels can be simplified. Therefore, light leaking at wide viewing angles and display quality can be improved.

### DESCRIPTION OF DRAWINGS

FIG. 1 illustrates a present adhesive structure for adhering a panel to a system frame.

FIG. 2 illustrates An adhesive structure for adhering a panel to a system frame of the present disclosure.

FIG. 3-6 illustrates steps of adhering the panel and the system frame of the present disclosure.

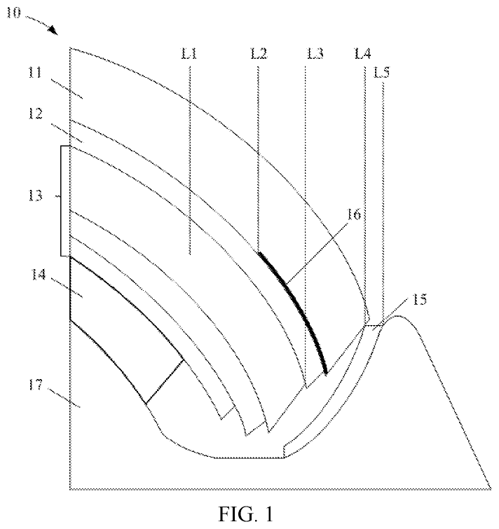

### DETAILED DESCRIPTION OF PREFERRED EMBODIMENTS

The illustrations of the following embodiments take the attached drawings as reference to indicate the present disclosure. The mentioned directional terms in the present disclosure, such as vertical, horizontal, upper, lower, left, right, front, back, are in the purpose of clarifying the relationships between components rather than in the purpose of limiting the embodiments of the present disclosure. Obviously, the described embodiments are only a part but not all of the embodiments. For a skilled person in the art, other embodiments obtained by referencing the embodiments of the present disclosure without creative efforts fall in the protected scope of the present disclosure.

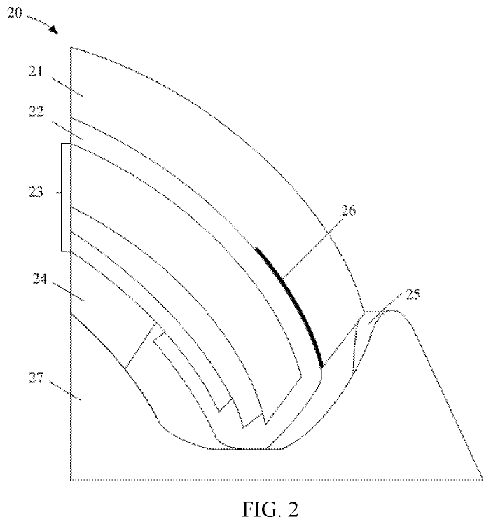

Please refer to FIG. 2 which illustrates An adhesive structure for adhering a panel to a system frame of the present disclosure. As shown in FIG. 2, a panel 20 includes a glass cover 21, an optically clear adhesive (OCA) 22, a display layer 23, a foam glue 24, a frame adhesive 25, ink 26, and a system frame 27. Differ from the present technology, a width of the OCA 22 of the present disclosure wider than a width of the display layer 23. After the glass cover 21 is adhered with the display layer by utilizing the OCA 22, parts of the OCA 22 which exceed the width of the display layer will be utilized to adhere the display layer 23 and the system frame 27. The foam glue 24 is disposed between the display layer 23 and the system frame 27 as an impact buffer to prevent the display layer 23 from damage while the panel 20 endures impact.

Please refer to FIG. 3 which illustrates steps of adhering the panel and the system frame of the present disclosure. As shown in FIG. 3, there are a heavy release film 322 and a light release film 324 disposed on different side of an OCA 32. The heavy release film 322 and the light release film 324 are utilized to adhere the OCA 32 on other surfaces. In a preferable embodiment of the present disclosure, a width of the heavy release film 322 and a width of the light release film 324 are wider than a width of the OCA 32. The width of the heavy release film 322 is wider than the width of the light release film 324. In the present technologies, heavy release film and light release films are removed entirely when adhering OCAs on the other surfaces. However, in the steps of adhering the panel and the system frame of the present disclosure, the heavy release film 322 and the light release film 324 are cut along the width of a display layer 33 before being removed. At first, only parts of the heavy release film 322 and the light release film 324 having the same width with the display layer 33 are removed instead of removing the whole heavy release film 322 and the whole light release film 324. The heavy release film 322 and the light release film 324 remain some portions at both ends.

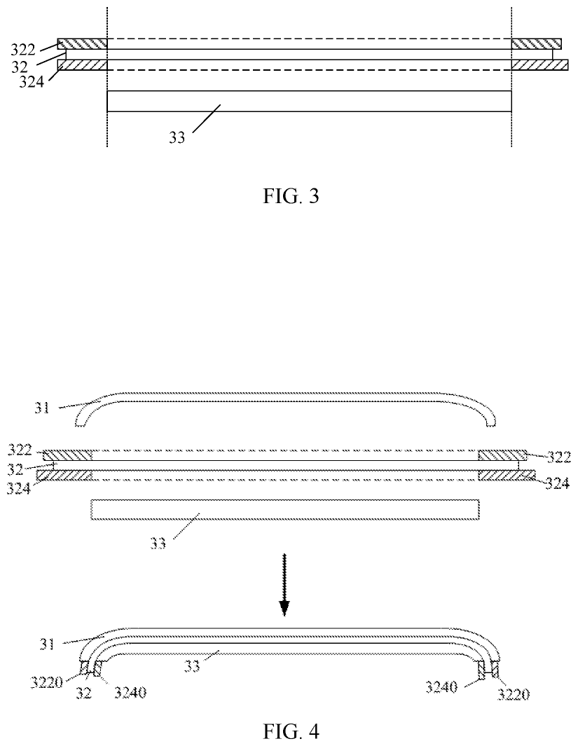

Please refer to FIG. 4 which illustrates following steps of adhering the panel and system frame after FIG. 3. In the following steps, first, removing parts of the heavy release film 322 as wide as the display layer 33 and adhering OCA 32 on a glass cover 31. Second, removing parts of the light release film 324 as wide as the display layer 33 and adhering another side of the OCA 32 on the display layer 33. Therefore, OCA 32 is adhered between the glass cover 31 and the display layer 33 to make the glass cover 31 and the display layer 33 fit with each other. The heavy release film 322 and the light release film 324 remain partly heavy release film 3220 and partly light release film 3240 respectively. The display layer 33 is flexible. Preferably, the display layer is flexible organic light-emitting diode display layer. Because the display layer 33 is flexible, the display layer 33 can perform full-screen display by being fitly adhered on the glass cover 31 through the OCA 32.

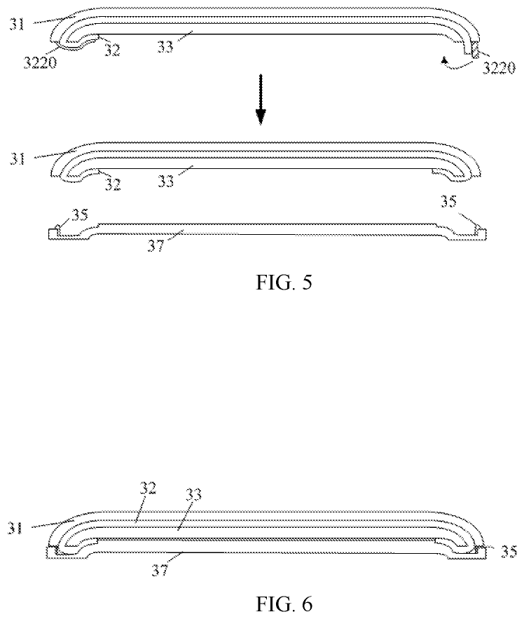

Please refer to FIG. 5 which illustrates following steps of adhering the panel and system frame after FIG. 4. After adhering the glass cover 31, the OCA 32, and the display layer 33, removing the remained partly light release film 3240 and bending the part of OCA 32 which exceeds the width of the display layer 33 and the partly heavy release film 3320 down to the display layer 33. Then removing the partly heavy release film 3320 and adhering the glass cover 31, the OCA 32, and the display layer 33 on a system frame 37. A frame adhesive 35 disposed at the edge of the system frame 37 is a buffer between the glass cover 31 and the system frame 37 to prevent the hard glass cover 31 and the system frame 37 from damage resulted from impacts.

FIG. 6 illustrates the structure of the panel and the system frame when steps of adhering are completed. The glass cover 31 fitly attaches with the system fame 37 through the frame adhesive 35. The glass cover 31 and the display layer 33 are adhered on the system frame through the OCA 32. Both ends of display layer 33 are covered by the bended OCA 32. The bended OCA 32 is not only a buffer between the display layer 33 and the system frame 37, but also a block for avoid light leaking from the gap between the glass cover and the system frame 37. Therefore, light leading is improved when watching the panel at a wider viewing angle.

In the adhesive structure and adhesive method for adhering the panel to the system frame, the glass cover, the display layer and the system frames can be adhered by one layer of OCA. Hence, steps of assembling the glass cover, the display layer, and the system frame can be simplified. Also manufacturing processes of panels can be simplified. Therefore, light leaking when watching the panel at a wider viewing angle and display quality are improved.

To conclude, embodiments disclosed above are preferable embodiments of the present disclosure. Any changes and modifications can be completed by a skilled person in the art on the basis of the concept of the present disclosure without creative effort should be viewed as protected scopes of the present disclosure.

1. An adhesive structure of a panel and a system frame, comprising:
the system frame;
the panel, comprising:
a glass cover;
a display layer configured to display images; and
an optically clear adhesive (OCA) configured to adhere the glass cover and the display layer;
a frame adhesive disposed between the glass cover and the system frame for adhering the glass cover and the system frame; and
a foam glue disposed between the display layer and the system frame for being a buffer between the display layer and the system frame;
wherein the OCA comprises partly OCA dispose at edge of the OCA; the partly OCA is a part of OCA which wider than the display layer; the partly OCA is disposed between the display layer and the system frame for adhering the display layer and the system frame.

2. An adhesive structure of a panel and a system frame, comprising:
the system frame; and
the panel, comprising:
a glass cover;
a display layer configured to display images; and
an optically clear adhesive (OCA) configured to adhere the glass cover and the display layer;
wherein the OCA comprises partly OCA dispose at edge of the OCA; the partly OCA is a part of OCA which wider than the display layer; the partly OCA is disposed between the display layer and the system frame for adhering the display layer and the system frame.

3. The adhesive structure of the panel and the system frame according to claim 2 further comprises a frame adhesive disposed between the glass cover and the system frame for adhering the glass cover and the system frame.

4. The adhesive structure of the panel and the system frame according to claim 2 further comprises a foam glue disposed between the display layer and the system frame for being a buffer between the display layer and the system frame.

5. An adhesive method of the panel and the system frame, comprising:
step one: cutting a light release film into a first light release film and a second light release film, wherein the light release film is on a first side of an optically clear adhesive (OCA); a width of the first light release film and a width of a display layer is equal; the second light release film is laterally disposed beside the first light release film;
step two: removing the first light release film and sticking the OCA on the display layer, wherein a width of the OCA is wider than the width of the display layer;
step three: bending the second light release film and parts of OCA being wider than the display layer down to the display layer;
step four: removing the second light release film and adhering the display layer on the system frame through the parts of OCA being bent down to the display layer.

6. The adhesive method of the panel and the system frame according to claim 5, wherein the step one comprises cutting a heavy release film into a first heavy release film and a second heavy release film, wherein the heavy release film is on a second side of the OCA; a width of the first heavy release film and a width of the display layer is equal; the second heavy release film is laterally disposed beside the first heavy release film.

7. The adhesive method of the panel and the system frame according to claim 6, wherein the step two comprises removing the first heavy release film and adhering a glass cover on the OCA.

8. The adhesive method of the panel and the system frame according to claim 6, wherein the step two comprises removing the second heavy release film after adhering the glass cover on the OCA.

9. The adhesive method of the panel and the system frame according to claim 5, wherein a width of the film and a width of the heavy release film are wider than the display layer; the width of the film is wider than the width of the heavy release film.

10. The adhesive method of the panel and the system frame according to claim 5 further comprises a frame adhesive disposed between the glass cover and the system frame for adhering the glass cover and the system frame.

11. The adhesive method of the panel and the system frame according to claim 5 further comprises a foam glue disposed between the display layer and the system frame for being a buffer between the display layer and the system frame.
